(19) United States
(12) Patent Application Publication
(10) Pub. No.: US 2010/0182339 A1
(43) Pub. Date: Jul. 22, 2010

(54) DATA PROCESSING APPARATUS AND METHOD

(76) Inventors: Nobutaka Kitajima, Kyoto (JP); Akira Tanaka, Osaka (JP); Tadashi Shibata, Osaka (JP)

Correspondence Address: MCDERMOTT WILL & EMERY LLP, 600 13TH STREET, NW, WASHINGTON, DC, 20005-3096, US

(21) Appl. No.: 12/668,180

(22) PCT Filed: May 28, 2008
(86) PCT No.: PCT/JP2008/001334

§ 371 Date: Jan. 7, 2010

(30) Foreign Application Priority Data
Sep. 26, 2007 (JP) 2007-249483

(51) Int. Cl. G09G 5/00; G06K 9/36

(52) U.S. Cl. 345/629; 382/232

(57) ABSTRACT

A stream processing section (12) analyzes input stream data and, if the stream data includes a compressed/coded graphics object, decodes the graphics object line by line and writes the decoded graphics object into a graphics object buffer (14), and, if the stream data includes control information of a graphics object, writes the control information into a control information buffer (13). A graphics control section (15) renders a graphics object stored in the graphics object buffer (14) in a graphics plane (16) based on control information stored in the control information buffer (13). When a decoding error has occurred, the stream processing section (12) restarts decoding from the next or a subsequent line.

### TECHNICAL FIELD

The present invention relates to a data processing apparatus and method that superimposes a graphics plane on another plane to produce a display screen of digital contents.

### BACKGROUND ART

Digital contents including moving pictures, sound, and the like have now been presented by means of, not only recording media such as optical discs, but also terrestrial, satellite, and other broadcasts and networks such as the Internet. As a compression scheme for such digital contents, Moving Picture Experts Group (MPEG) 2 is widely known. According to this standard, digital contents are transmitted in the form of multiplexed stream data obtained by forming packs, or transport stream (TS) packets, from packetized elementary stream (PES) packets each containing only one type of data, such as video, audio, or appended data. On the receiver side, received stream data is demultiplexed into packs or TS packets. From these packs or TS packets, PES packets are reorganized and then subjected to processing appropriate to each data type, thereby to reproduce digital contents.

If an error occurs in stream data due to a defect on an optical disc, noise on a transmission path, and the like, a CRC error may occur in decoding of a start code of a pack or a packet, a code representing the packet type, a code representing the packet length, and the like. As a result, a delimiter of the pack or the packet may not be detected, and thus, the system may crash. Conventionally, to solve this problem, when stream data is demultiplexed into packs to determine the type of each packet and send the packet to a decoder, head sync information of packs transferred from an optical disc drive is used as a trigger for starting operation of an internal sequencer (see Patent Document 1, for example).

### CITATION LIST

### PATENT DOCUMENT

PATENT DOCUMENT 1: Japanese Patent Publication No. H09-91878

### SUMMARY OF THE INVENTION

### Technical Problem

Blu-ray Disc (BD) that has made its debut recently presents enhanced interactive user interface in addition to high-definition moving-image playback. In BD, a graphics plane in which buttons (graphics objects) for executing various commands are rendered is displayed by being superimposed on another plane such as a moving picture plane. This permits a menu to be displayed on the screen to allow execution of a desired operation during playback of a moving picture. For this reason, in BD, a graphics stream for a graphics object is defined.

In BD, pixel data of a graphics object is run-length coded and transmitted. On the receiver side, the coded data is decoded to restore the original pixel data. At this time, if a decoding error occurs, the system may crash, or it may take time to recover from the error. The conventional technique described above finds it difficult to deal with even such a case that an error is included in an elementary stream.

When the head position of the next graphics object is detected based on the length of run length data, this detection of the head position of the next graphics object will no more be allowed if data corruption such as partial loss or insertion occurs in the run length data. If this occurs, not only pixel data of the graphics object in which the decoding error has occurred but also pixel data of the subsequent graphics object(s) will fail to be restored normally.

Also, if a buffer is reset to recover from a decoding error, the other graphics object or objects in the buffer that are normally decoded will also be erased. If this occurs, no button will be displayed when the menu is called until a new graphics object is received in the next frame. In particular, in the case of pre-loading a graphics object to read it from the buffer later as required, since the pre-loaded graphics object is not resent, the graphics object erased under resetting of the buffer will never be displayed.

In view of the above, the objective of the present invention is providing a data processing apparatus for superimposing a graphics plane on another plane to produce a display screen of digital contents, in which even if a decoding error occurs in a graphics object to be rendered in a graphics plane, recovery from the error can be made to permit display of the graphics object without the necessity of clearing a buffer.

### Solution to the Problem

To solve the problem described above, according to the present invention, the data processing apparatus for superimposing a graphics plane on another plane to produce a display screen of digital contents includes: a first storage section configured to store a decoded graphics object; a second storage section configured to store control information of a graphics object; a stream processing section configured to analyze input stream data and, if the stream data includes a compressed/coded graphics object, decode the graphics object line by line and write the decoded graphics object into the first storage section, and, if the stream data includes control information of a graphics object, write the control information into the second storage section; and a graphics control section configured to render a graphics object stored in the first storage section in the graphics plane based on control information stored in the second storage section, wherein when a decoding error has occurred, the stream processing section restarts decoding from a next or a subsequent line. With this configuration, even if a decode error occurs in a graphics object, decoding is restarted from the next or a subsequent line. Therefore, recovery from the error can be made to permit display of the graphics object without causing the system to crash and without the necessity of resetting the buffer.

Specifically, the stream processing section writes dummy data into the first storage section as pixel data for a line in which a decoding error has occurred (specifically, the dummy data is pixel data of a line immediately preceding the line in which a decoding error has occurred), and detects an end of the line to restart decoding from a next line. With this configuration, the line having data corruption is complemented by dummy data, permitting display of the graphics object in its near original shape.

Specifically, when a decoding error has occurred in at least a predetermined number of lines, the stream processing section writes dummy data into the first storage section as pixel data for a line range from a line in which the decoding error has occurred through a final line, and restarts decoding from a first line of a next compressed/coded graphics object. With this configuration, the graphics object in which a decode error has occurred can be displayed with its original pixel data up to the line until which normal decoding has been successful.

Specifically, the data processing apparatus further includes a third storage section configured to store a previously prepared graphics object, wherein when a decoding error has occurred in at least a predetermined number of lines, the stream processing section restarts decoding from a first line of a next compressed/coded graphics object, and the graphics control section renders a graphics object stored in the third storage section in the graphics plane in place of a graphics object in which a decoding error has occurred in at least the predetermined number of lines in the stream processing section. Alternatively, the stream processing section acquires, from the stream data including a compressed/coded graphics object, a width and height of the graphics object and writes the acquired width and height into the second storage section, and when a decoding error has occurred in at least a predetermined number of lines, restarts decoding from a first line of a next compressed/coded graphics object, and the graphics control section renders a graphics object produced based on a width and height stored in the second storage section in the graphics plane in place of the graphics object in which a decoding error has occurred in at least the predetermined number of lines in the stream processing section. With these configurations, a graphics object of another design can be displayed in place of a graphics object that has been so corrupted that its original is no more recognizable.

Preferably, the graphics control section puts a predetermined mark on the graphics object in which a decoding error has occurred in the stream processing section, a graphics object stored in the third storage section, and the graphics object produced based on a width and height stored in the second storage section, and renders such graphics objects with the mark in the graphics plane. With this configuration, the user can be notified that the displayed graphics object is not the original one.

Preferably, for a specified graphics object, out of a graphics object in which a decoding error has occurred in the stream processing section, the graphics control section makes the specified graphics object transparent and renders the transparent graphics object in the graphics plane, or renders a graphics object stored in the third storage section, or a graphics object produced based on a width and height stored in the second storage section, in the graphics plane in place of the specified graphics object. With this configuration, display can be switched among graphics objects, and also switching between display and non-display can be made, by the user's will.

### Advantages of the Invention

As described above, according to the present invention, in a data processing apparatus for superimposing a graphics plane on another plane to produce a display screen of digital contents, even if a decode error occurs in a graphics object to be rendered in the graphics plane, recovery from the error can be made to permit display of the graphics object without the necessity of clearing the buffer.

### BRIEF DESCRIPTION OF THE DRAWINGS

FIG. 1 is a block diagram of a data processing apparatus of an embodiment of the present invention.

FIG. 2 is a view showing a data structure of graphics PES.

FIG. 3 is a view showing a graphics object observed when a decoding error has occurred in one line.

FIG. 4 is a view showing a graphics object observed when decoding errors have occurred in a plurality of lines.

FIG. 5 is a view showing an example of display of a graphics plane.

FIG. 6 is a view showing an example of switching of display among graphics objects.

### DESCRIPTION OF REFERENCE CHARACTERS

12 Stream processing section
13 Control information buffer (second storage section)
14 Graphics object buffer (first storage section)
15 Graphics control section

16 Graphics plane

17 Substitute graphics object buffer (third storage section)

### DESCRIPTION OF EMBODIMENTS

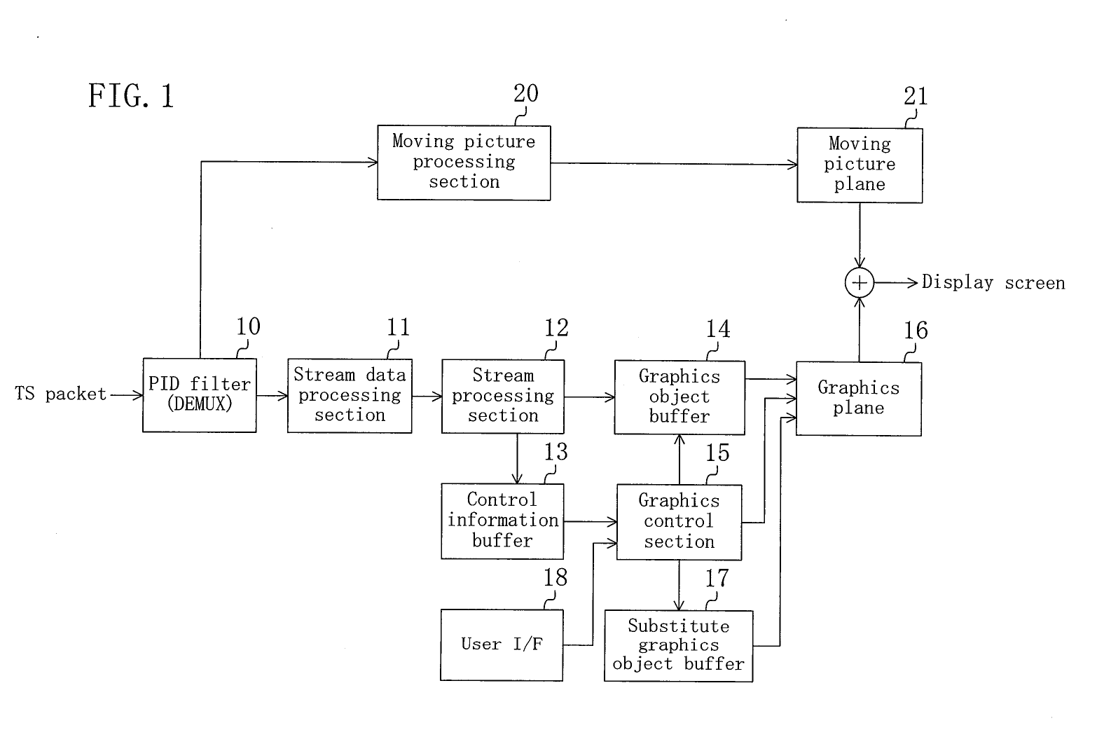

An embodiment of the present invention will be described hereinafter with reference to the drawings. FIG. 1 shows a configuration of a data processing apparatus of an embodiment of the present invention. A packet identifier (PID) filter 10 receives TS packets (e.g., Blu-ray Disc Audio Video (BDAV) MPEG-2 TS packets read from a BD-ROM) in which video PES, audio PES, and the like are multiplexed, and demultiplexes the TS into PES packets according to PID (DEMUX processing). The BDAV MPEG-2 TS includes, not only video PES, audio PES, and subtitle PES, but also graphics PES for transmitting a button (graphics object) appearing on the screen upon menu calling and the like. A stream data buffer 11 temporarily accumulates graphics PES obtained from the demultiplexing by the PID filter 10.

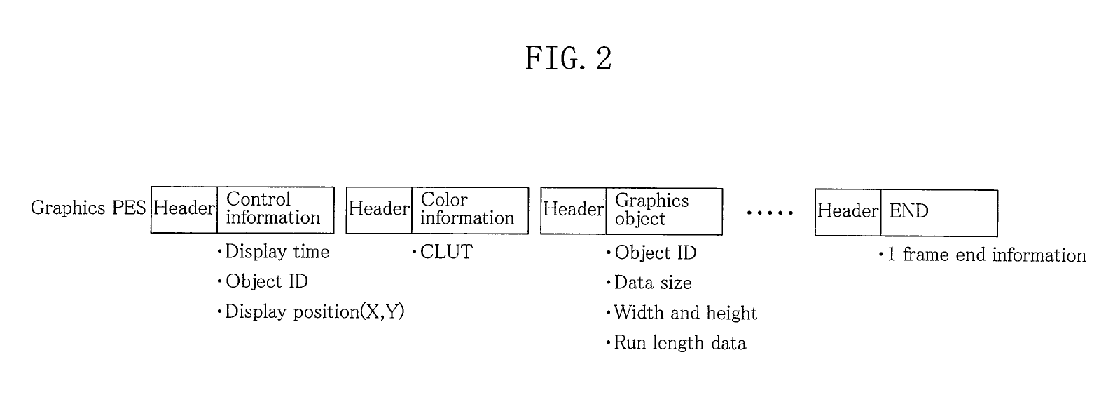

FIG. 2 shows a data structure of graphics PES. The graphics PES is constructed of one or a plurality of segments. Control information segment includes the display time, ID, display position, etc. of a graphics object. Color information segment includes color lookup table (CLUT) information for coloring the graphics object. Graphics object segment includes the ID, data size, width and height, run-length data, etc. of the graphics object. End segment includes information indicating the end of one frame. The header of each segment includes information on the type and length of the segment.

Returning to FIG. 1, a stream processing section 12 analyzes the headers of the graphics PES received from the buffer 11 to determine the type of each segment and performs processing specific to each type of segment. Specifically, for the control information segment and the color information segment, the stream processing section 12 writes the display time, the display position, and the CLUT included in the payload into a control information buffer 13. For the graphics object segment, the stream processing section 12 decodes the run-length data included in the payload line by line and writes the decoded data into a graphics object buffer 14, and also writes the width and height of the graphics object into the control information buffer 13.

A graphics control section 15 renders the graphics object stored in the graphics object buffer 14 in a graphics plane 16 based on the control information (the display time, the display position, the CLUT, etc.) stored in the control information buffer 13. The graphics plane 16 is a frame memory in which one or a plurality of graphics objects are rendered. In BD, the graphics plane 16 has a size of 1920×1080 at maximum, and can display full-color and translucent graphics objects with 24-bit color and 8-bit alpha. The graphics plane 16 is superimposed on a moving picture plane 21 that holds a moving picture frame decoded by a moving picture processing section 20, to be output as the display screen. Note that a subtitle plane and the like are also superimposed on the graphics plane although description on this is omitted here.

The graphics control section 15 renders, not only the graphics object stored in the graphics object buffer 14, but also any of graphics objects defined with various sizes, colors, patterns, and fonts previously prepared in a substitute graphics object buffer 17, or a self-produced graphics object. In addition, the graphics control section 15 performs switching between display/non-display of a graphics object and switching of display among graphics objects according to an instruction from the user interface 18. The operation of the graphics control section 15 will be described in detail later.

Next, the operation of this apparatus followed when a decoding error has occurred in the stream processing section 12 will be described. If run length data is corrupted, the stream processing section 12 will fail to decode the run length data that is now out of standard, or the line width of pixel data obtained from the decoding will be different from the defined one. When such a decoding error has occurred, the stream processing section 12 restarts decoding from the next line. In BD, the run length data in the graphics object data has a code representing the line end inserted at the end of each line data. By detecting this code, therefore, the line immediately succeeding the line in which a decoding error has occurred can be easily found.

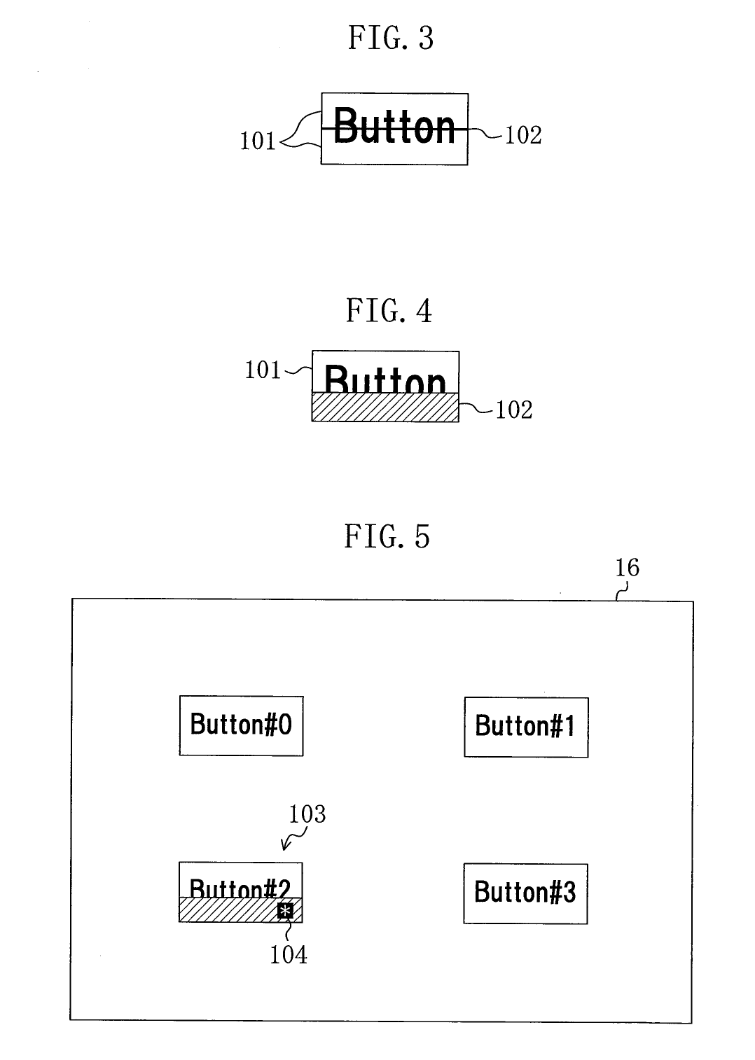

Also, when a decoding error has occurred, the stream processing section 12 writes dummy data into the graphics object buffer 14 as pixel data for the line of which correct decoding has failed. As a result, as shown in FIG. 3, the graphics object is displayed with original pixel data 101 for correctly decoded lines and dummy data 102 for the line in which a decoding error has occurred.

As the dummy data, pixel data of a single color such as white color, black color, and transparent color can be used. In particular, use of transparent-color dummy data will make the complemented portion inconspicuous. Also, as the dummy data, pixel data of the line immediately preceding the line in which a decoding error has occurred may be used. This will make the complemented portion most inconspicuous.

If decoding errors occur in a plurality of lines in one graphics object, these lines may be complemented by dummy data. However, if decoding errors occur in a comparatively large number of lines, or the code representing the line end is lost failing to decode a graphics object having the defined width and height, the line range from the line in which a decoding error has occurred through the last line may be complemented by dummy data. In other words, when decoding errors have occurred in at least a predetermined number of lines, the stream processing section 12 writes dummy data into the graphics object buffer 14 as pixel data for the line range from the line in which a decoding error has occurred through the final line. As a result, as shown in FIG. 4, the graphics object is displayed with original pixel data 101 for the lines preceding the line in which a decoding error has occurred and with dummy data 102 for the line in which a decoding error has occurred and the subsequent lines. The predetermined number of lines, as a criterion for judging the magnitude of occurrence of decoding errors, may be determined depending on the number of lines of the graphics object, i.e., the height of the graphics object.

When decoding errors have occurred in at least a predetermined number of lines, the stream processing section 12 may stop decoding for the graphics object in which such decoding errors have occurred, to restart decoding from the first line of the next graphics object. Specifically, the stream processing section 12 skips stream data until coming across the next start code (0×000001). Once detecting the start code, the stream processing section 12 determines whether the stream ID is 0×BD or not, and, if not, then searches for the second next start code. If the stream ID is 0×BD, the stream processing section 12 determines whether the stream data includes a graphics object or not, and if the stream data includes a graphics object, restarts decoding from the first line of this graphics object.

When decoding errors have occurred in at least a predetermined number of lines as described above, display of a completely different graphics object may sometimes be preferred to display of a graphics object complemented by dummy data and a graphics object of which decoding has been stopped halfway. In other words, display of a graphics object of another design previously prepared may be preferred to display of a graphics object from which the original is no more recognizable. Hence, when decoding errors have occurred in at least a predetermined number of lines, the stream processing section 12 writes, into the control information buffer 13, error information indicating that a number of decoding errors have occurred in the graphics object. The graphics control section 15, referring to the error information stored in the control information buffer 13, renders a graphics object stored in the substitute graphics object buffer 17 or a self-produced graphics object in the graphics plane 16, in place of the graphics object in which a number of decoding errors have occurred. In the former case of using a graphics object in the substitute graphics object buffer 17, a graphics object having a width and a height closest to those stored in the control information buffer 13 is selected and rendered in the graphics plane 16. In the latter case of using a self-produced graphics object, a graphics object filled with one color or a predetermined pattern is produced based on the width and the height stored in the control information buffer 13, or a basic graphics object template is enlarged or contracted, and the resultant graphics object is rendered in the graphics plane 16.

When displaying a graphics object complemented by dummy data, a graphics object stored in the substitute graphics object buffer 17, and a graphics object produced by the graphics control section 15, it is desirable to indicate that these are not the original graphics object. Therefore, the graphics control section 15 puts a predetermined mark on such graphics objects when rendering the graphics objects in the graphics plane 16. FIG. 5 shows an example of display of the graphics plane 16. In this example, four graphics objects are rendered in the graphics plane 16. Among them, a graphics object 103 complemented by dummy data has a mark 104 (an open asterisk in this example) put thereon. With this mark, the user can be notified that the displayed graphics object is not the original one. Although the mark 104 is put inside the frame of the graphics object in this example, it may be put outside the frame of the graphics object.

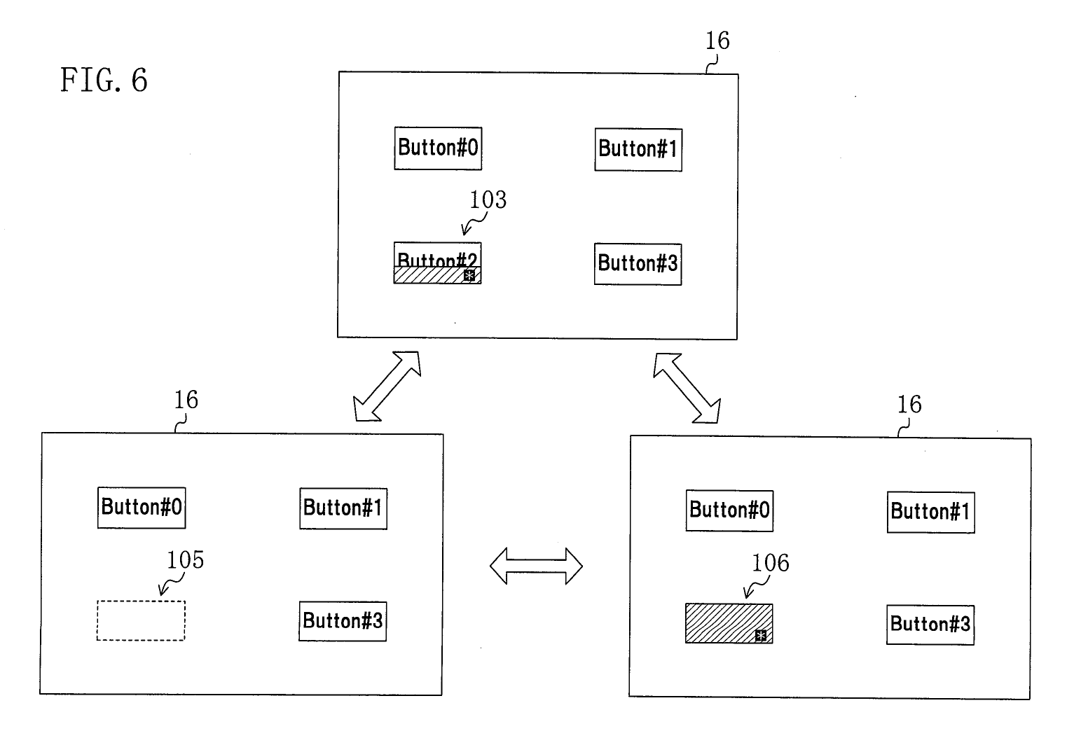

It is desirable that display is switchable among a graphics object complemented by dummy data, a graphics object stored in the substitute graphics object buffer 17, and a graphics object produced by the graphics control section 15, and that switching between display and non-display can be made, by the user's intention. Thus, the graphics control section 15 switches among graphics objects for display, and switches between display/non-display according to an instruction of the user given via a user interface 18. FIG. 6 shows an example of switching of display among graphics objects. In the graphics plane 16 in the upper center part of FIG. 6, the graphics object 103 complemented by dummy data is displayed. In the graphics plane 16 in the lower left part, a transparent graphics object 105 is displayed in place of the graphics object in which a decoding error has occurred. In other words, the graphics object 103 in the graphics plane 16 in the upper center part is not displayed. In the graphics plane 16 in the lower right part, a graphics object 106 of another design (a graphics object stored in the substitute graphics object buffer 17 or a graphics object produced by the graphics control section 15) is displayed in place of the graphics object in which a decoding error has occurred. These three display states can be switched according to an instruction of the user. The color, pattern, font, etc. of the graphics object 106 may be arbitrarily selected to suit the user's preference.

As described above, in the data processing apparatus of this embodiment, even if a decoding error occurs in a graphics object, decoding is restarted from the next or a subsequent line. Hence, recovery from the error can be made to permit display of the graphics object without causing the system to crash and without the necessity of resetting the buffer.

### INDUSTRIAL APPLICABILITY

According to the data processing apparatus of the present invention, even if a decoding error occurs in a graphics object to be rendered in a graphics plane, recovery from the error can be made to permit display of the graphics object without the necessity of clearing the buffer. Hence, the inventive data processing apparatus is useful in BD players, BD recorders, magnetic disc recorders, digital broadcast receivers, Internet receivers, and the like.

1. A data processing apparatus for superimposing a graphics plane on another plane to produce a display screen of digital contents, comprising:
a first storage section configured to store a decoded graphics object;
a second storage section configured to store control information of a graphics object;
a stream processing section configured to analyze input stream data and, if the stream data includes a compressed/coded graphics object, decode the graphics object line by line and write the decoded graphics object into the first storage section, and, if the stream data includes control information of a graphics object, write the control information into the second storage section; and
a graphics control section configured to render a graphics object stored in the first storage section in the graphics plane based on control information stored in the second storage section,
wherein
when a decoding error has occurred, the stream processing section restarts decoding from a next or a subsequent line.

2. The data processing apparatus of claim 1, wherein the stream processing section writes dummy data into the first storage section as pixel data for a line in which a decoding error has occurred, and detects an end of the line to restart decoding from a next line.

3. The data processing apparatus of claim 2, wherein the dummy data is pixel data of a line immediately preceding the line in which a decoding error has occurred.

4. The data processing apparatus of claim 1, wherein when a decoding error has occurred in at least a predetermined number of lines, the stream processing section writes dummy data into the first storage section as pixel data for a line range from a line in which the decoding error has occurred through a final line, and restarts decoding from a first line of a next compressed/coded graphics object.

5. The data processing apparatus of claim 2 or 4, wherein the graphics control section puts a predetermined mark on a graphics object in which a decoding error has occurred in the stream processing section and renders the graphics object with the mark in the graphics plane.

6. The data processing apparatus of claim 1, further comprising:
a third storage section configured to store a previously prepared graphics object, wherein
when a decoding error has occurred in at least a predetermined number of lines, the stream processing section restarts decoding from a first line of a next compressed/coded graphics object, and
the graphics control section renders a graphics object stored in the third storage section in the graphics plane in place of a graphics object in which a decoding error has occurred in at least the predetermined number of lines in the stream processing section.

7. The data processing apparatus of claim 6, wherein the graphics control section puts a predetermined mark on a graphics object stored in the third storage section and renders the graphics object with the mark on the graphics plane.

8. The data processing apparatus of claim 1, wherein the stream processing section acquires, from the stream data including a compressed/coded graphics object, a width and height of the graphics object and writes the acquired width and height into the second storage section, and when a decoding error has occurred in at least a predetermined number of lines, restarts decoding from a first line of a next compressed/coded graphics object, and
the graphics control section renders a graphics object produced based on a width and height stored in the second storage section in the graphics plane in place of a graphics object in which a decoding error has occurred in at least the predetermined number of lines in the stream processing section.

9. The data processing apparatus of claim 8, wherein the graphics control section puts a predetermined mark on the produced graphics object and renders the graphics object with the mark in the graphics plane.

10. The data processing apparatus of claim 1, wherein for a specified graphics object, out of a graphics object in which a decoding error has occurred in the stream processing section, the graphics control section makes the specified graphics object transparent and renders the transparent graphics object in the graphics plane.

11. The data processing apparatus of claim 1, further comprising:
a third storage section configured to store a previously prepared graphics object, wherein
for a specified graphics object, out of a graphics object in which a decoding error has occurred in the stream processing section, the graphics control section renders a graphics object stored in the third storage section in the graphics plane in place of the specified graphics object.

12. The data processing apparatus of claim 1, wherein the stream processing section acquires, from the stream data including a compressed/coded graphics object, a width and height of the graphics object and writes the acquired width and height into the second storage section, and
for a specified graphics object, out of a graphics object in which a decoding error has occurred in the stream processing section, the graphics control section renders a graphics object produced based on a width and height stored in the second storage section in the graphics plane in place of the specified graphics object.

13. A data processing method for superimposing a graphics plane on another plane to produce a display screen of digital contents, comprising the steps of:
(1) analyzing input stream data and, if the stream data includes a compressed/coded graphics object, decoding the graphics object line by line and writing the decoded graphics object into a first storage section configured to store a decoded graphics object, and, if the stream data includes control information of a graphics object, writing the control information into a second storage section configured to store control information of a graphics object; and
(2) rendering a graphics object stored in the first storage section in the graphics plane based on control information stored in the second storage section,
wherein
when a decoding error has occurred in the step (1), decoding is restarted from a next or a subsequent line.

14. The data processing method of claim 13, wherein dummy data is written into the first storage section as pixel data for a line in which a decoding error has occurred in the step (1), and an end of the line is detected to restart decoding from a next line.

15. The data processing method of claim 14, wherein the dummy data is pixel data of a line immediately preceding the line in which a decoding error has occurred.

16. The data processing method of claim 13, wherein when a decoding error has occurred in at least a predetermined number of lines in the step (1), dummy data is written into the first storage section as pixel data for a line range from a line in which the decoding error has occurred through a final line, and decoding is restarted from a first line of a next compressed/coded graphics object.

17. The data processing method of claim 14 or 16, wherein a predetermined mark is put on a graphics object in which a decoding error has occurred in the step (1), and the graphics object with the mark is rendered in the graphics plane.

18. The data processing method of claim 13, wherein when a decoding error has occurred in at least a predetermined number of lines in the step (1), decoding is restarted from a first line of a next compressed/coded graphics object, and a graphics, object stored in a third storage section configured to store a previously prepared graphics object is rendered in the graphics plane in place of a graphics object in which a decoding error has occurred in at least the predetermined number of lines.

19. The data processing method of claim 18, wherein a predetermined mark is put on a graphics object stored in the third storage section, and the graphics object with the mark is rendered in the graphics plane.

20. The data processing method of claim 13, further comprising the step of:
(3) acquiring, from the stream data including a compressed/coded graphics object, a width and height of the graphics object and writing the acquired width and height into the second storage section,
wherein
when a decoding error has occurred in at least a predetermined number of lines in the step (1), decoding is restarted from a first line of a next compressed/coded graphics object, and a graphics object produced based on a width and height stored in the second storage section is rendered in the graphics plane in place of a graphics object in which a decoding error has occurred in at least the predetermined number of lines.

21. The data processing method of claim 20, wherein a predetermined mark is put on the produced graphics object, and the graphics object with the mark is rendered in the graphics plane.

22. The data processing method of claim 13, wherein for a specified graphics object, out of a graphics object in which a decoding error has occurred in the step (1), the graphics object is made transparent and rendered in the graphics plane.

23. The data processing method of claim 13, wherein for a specified graphics object, out of a graphics object in which a decoding error has occurred in the step (1), a graphics object stored in a third storage section configured to store a previously prepared graphics object is rendered in the graphics plane in place of the specified graphics object.

24. The data processing method of claim 13, further comprising the step of:
(3) acquiring, from the stream data including a compressed/coded graphics object, a width and height of the graphics object and writing the acquired width and height into the second storage section,
wherein
for a specified graphics object, out of a graphics object in which a decoding error has occurred in the step (1), a graphics object produced based on a width and height stored in the second storage section is rendered in the graphics plane in place of the specified graphics object.
